(19) United States
(12) Patent Application Publication
(10) Pub. No.: US 2026/0116332 A1
(43) Pub. Date: Apr. 30, 2026

(54) AIRBAG APPARATUS

(71) Applicant: HYUNDAI MOBIS CO., LTD., Seoul (KR)

(72) Inventor: Sang won HWANGBO, Yongin-si (KR)

(73) Assignee: HYUNDAI MOBIS CO., LTD., Seoul (KR)

(21) Appl. No.: 19/363,334

(22) Filed: Oct. 20, 2025

(30) Foreign Application Priority Data
Oct. 29, 2024 (KR) 10-2024-0150108
Oct. 29, 2024 (KR) 10-2024-0150109

(51) Int. Cl. B60R 21/233; B60R 21/207; B60R 21/2334; B60R 21/235

(52) U.S. Cl. CPC B60R 21/233; B60R 21/207; B60R 21/2334; B60R 21/235; B60R 2021/23538

(57) ABSTRACT

An airbag apparatus includes: a side chamber installed in a seatback of a seat of a vehicle, and configured to be deployed to protrude from a lateral side of the seatback and face a lateral side of a seated occupant in the seat; and a front chamber connected to the side chamber to allow gas to flow therebetween, and configured to be deployed to protrude in a direction bent from the side chamber and face a front surface of the seated occupant, the front chamber including a base panel coupled to the side chamber, and a cover panel coupled to an outer peripheral portion of the base panel.

### CROSS-REFERENCE TO RELATED APPLICATIONS

This application claims priority from and the benefit of Korean Patent Application Nos. 10-2024-0150108 and 10-2024-0150109, both filed on October 29, 2024, which are hereby incorporated by reference for all purposes as if set forth herein.

### TECHNICAL FIELD

Exemplary embodiments of the present disclosure relate to an airbag apparatus, and more particularly, to an airbag apparatus which is deployed at a lateral side and a front side of a seated occupant in the event of a collision accident.

### BACKGROUND

In the event of a frontal or side collision accident of a vehicle, as an upper body of a seated occupant in a driver seat or a passenger seat moves, a significant impact may be applied to the seated occupant even when a front airbag is deployed. In addition, a collision may occur between seated occupants in a driver seat and a passenger seat, or an injury may be caused to an occupant due to impact against an armrest, a seat, or the like.

Therefore, there is a need for an airbag apparatus that is deployed at a lateral side and a front side of a seated occupant in the event of a vehicle collision accident.

The background art of the present disclosure is disclosed in Korean Patent Laid-open Publication No. 10-2022-0029737 (published on Mar. 8, 2022, entitled “SURROUNDING AIRBAG ASSEMBLIES”).

### SUMMARY

Various embodiments are directed to an airbag apparatus that may be smoothly deployed to block a side and a front of a seated occupant in the event of a vehicle collision accident, and may suppress damage to a neck portion of the seated occupant.

An airbag apparatus according to an embodiment of the present disclosure may include: a side chamber disposed at or installed in a seatback of a seat of a vehicle, and configured to be deployed to protrude from a lateral side of the seatback and face a lateral side of a seated occupant in the seat; and a front chamber connected to the side chamber to allow gas to flow between the front chamber and the side chamber, and configured to be deployed to protrude in a direction bent from the side chamber and face a front surface of the seated occupant, the front chamber including a base panel coupled to the side chamber, and a cover panel coupled to an outer peripheral portion of the base panel.

The base panel may include a first base portion positioned to face the side chamber, a second base portion bent from a first side of the first base portion with respect to a width direction of the first base portion, the second base portion being positioned to face the seated occupant, and a third base portion bent from a second side of the first base portion with respect to the width direction of the first base portion, the third base portion being positioned to face away from the seated occupant with the second base portion interposed between the third base portion and the seated occupant.

The side chamber may include an inner panel positioned to face the seated occupant, and to which the first base portion is attached, and an outer panel positioned to face away from the seated occupant with the inner panel interposed between the outer panel and the seated occupant. The inner panel and the base panel may respectively include through-holes aligned with each other to allow gas to flow between the side chamber and the front chamber.

A hole-defining portion of the inner panel surrounding the corresponding through-hole and a hole-defining portion of the base panel surrounding the corresponding through-hole may be sewn to each other so that gas is prevented from leaking between the inner panel and the base panel.

The cover panel may include a first cover portion spaced apart from the first base portion, and positioned to face the first base portion, a second cover portion bent from a first side of the first cover portion with respect to a longitudinal direction of the first cover portion, the second cover portion being positioned above the first cover portion, and a third cover portion bent from a second side of the first cover portion with respect to the longitudinal direction of the first cover portion, the third cover portion being positioned below the first cover portion.

The first base portion and the first cover portion may extend in a vertical direction.

A width of the first base portion may be identical to a width of the first cover portion.

The width of the first base portion may be constant along a longitudinal direction of the first base portion. The width of the first cover portion may be constant along the longitudinal direction of the first cover portion.

In a state where the base panel and the cover panel are not coupled, a planar shape of the base panel may be either a rectangular shape or a rectangular shape with rounded corners.

In a state where the base panel and the cover panel are not coupled, a planar shape of the cover panel may be either a rectangular shape or a rectangular shape with rounded corners.

In a deployed state of the front chamber, the front chamber may have a rectangular parallelepiped shape.

The seatback may include a seatback frame, and an outer covering that encloses the seatback frame to prevent the seatback frame from being exposed. When the side chamber and the front chamber are deployed, the outer covering may be ruptured by at least one of the side chamber or the front chamber.

The airbag apparatus may further include an upper tether connecting an upper portion of the seatback and the side chamber.

The airbag apparatus may further include a lower tether connecting a side portion of the seatback and the side chamber.

The airbag apparatus may further include an inflator positioned in the side chamber and supported by the seatback, the inflator being configured to provide gas that deploys the side chamber and the front chamber.

The side chamber may include at least a first side chamber internal tether to limit a thickness of the side chamber.

The front chamber may include at least one front chamber internal tether to limit a thickness of the front chamber.

An airbag apparatus according to an embodiment of the present disclosure may include: a side chamber disposed at or installed in a seatback of a seat of a vehicle, and configured to be deployed to protrude from a lateral side of the seatback and face a lateral side of a seated occupant in the seat; and a front chamber connected to the side chamber to allow gas to flow between the front chamber and the side chamber, and configured to be deployed to protrude in a direction bent from the side chamber and face a front surface of the seated occupant, the front chamber including a base panel coupled to the side chamber, and a cover panel coupled to an outer peripheral portion of the base panel. A thickness of an upper portion of the front chamber may be greater than a thickness of an intermediate portion between the upper portion and a lower portion of the front chamber.

The base panel may include a first base portion positioned to face the side chamber, a second base portion bent from a first side of the first base portion with respect to a width direction of the first base portion, the second base portion being positioned to face the seated occupant, and a third base portion bent from a second side of the first base portion with respect to the width direction of the first base portion, the third base portion being positioned to face away from the seated occupant with the second base portion interposed between the third base portion and the seated occupant.

The cover panel may include a first cover portion spaced apart from the first base portion, and positioned to face the first base portion, a second cover portion bent from a first side of the first cover portion with respect to a longitudinal direction of the first cover portion, the second cover portion being positioned above the first cover portion, and a third cover portion bent from a second side of the first cover portion with respect to the longitudinal direction of the first cover portion, the third cover portion being positioned below the first cover portion.

The first cover portion may include a tapered portion having a width increasing from an intermediate point between an upper end and a lower end of the first cover portion toward the upper end of the first cover portion, and a narrow-width portion extending from the intermediate point of the first cover portion to the lower end of the first cover portion, with a width identical to a width of the tapered portion.

Each of the second base portion and the third base portion may include an inclined base edge corresponding to one of inclined cover edges of the tapered portion, and a parallel base edge corresponding to one of parallel cover edges of the narrow-width portion that are parallel to a longitudinal direction of the cover panel.

The first cover portion may include a first tapered portion having a width increasing from an intermediate point between an upper end and a lower end of the first cover portion toward the upper end of the first cover portion, and a second tapered portion having a width increasing from the intermediate point of the first cover portion toward the lower end of the first cover portion.

Each of the second base portion and the third base portion may include a first inclined base edge corresponding to one of first inclined cover edges of the first tapered portion, and a second inclined base edge corresponding to one of second inclined cover edges of the second tapered portion.

The front chamber may include at least one front chamber internal tether configured to limit a thickness of the front chamber.

The side chamber may include an inner panel positioned to face the seated occupant, and to which the first base portion is attached, and an outer panel positioned to face away from the seated occupant with the inner panel interposed between the outer panel and the seated occupant. The inner panel and the base panel may respectively include through-holes aligned with each other to allow gas to flow between the side chamber and the front chamber.

A hole-defining portion of the inner panel surrounding the corresponding through-hole and a hole-defining portion of the base panel surrounding the corresponding through-hole may be sewn to each other so that gas is prevented from leaking between the inner panel and the base panel.

The airbag apparatus may further include an upper tether connecting an upper portion of the seatback and the side chamber.

The airbag apparatus may further include a lower tether connecting a side portion of the seatback and the side chamber.

The airbag apparatus may further include an inflator positioned in the side chamber and supported by the seatback, the inflator being configured to provide gas that deploys the side chamber and the front chamber.

The seatback may include a seatback frame, and an outer covering that encloses the seatback frame to prevent the seatback frame from being exposed. When the side chamber and the front chamber are deployed, the outer covering may be ruptured by at least one of the side chamber or the front chamber.

The side chamber may include at least a first side chamber internal tether to limit a thickness of the side chamber.

According to the present disclosure, in the event of a vehicle collision accident, gas may rapidly flow from a side chamber to a front chamber without blockage, so that the side chamber and the front chamber may be smoothly deployed to block a lateral side and a front side of a seated occupant.

According to the present disclosure, a thickness of an upper portion of the front chamber may be stably maintained by a second cover portion of a cover panel interposed between a second base portion and a third base portion of a base panel. Accordingly, in the event of a vehicle collision accident, the upper portion of the front chamber may firmly support the neck and head of the seated occupant, thereby preventing serious injury to the neck and head of the seated occupant.

According to the present disclosure, an airbag apparatus may include a front chamber that is deployed to have a greater thickness in an upper portion thereof near the neck and the head of the seated occupant than in an intermediate portion thereof below the upper portion. Therefore, a limited amount of gas discharged from an inflator in the event of a vehicle collision accident may be effectively distributed inside the front chamber, and injury to the neck and the head of the seated occupant may be more reliably prevented.

### BRIEF DESCRIPTION OF THE DRAWINGS

FIG. 1 is a perspective view illustrating an airbag apparatus in an inflated and deployed state according to a first embodiment of the present disclosure.

FIG. 2 is a front view schematically illustrating an interior of a seatback of FIG. 1.

FIG. 3 is a developed view illustrating an example of an inner panel and an outer panel included in a side chamber of FIG. 1.

FIG. 4 is a developed view illustrating an example of a base panel and a cover panel included in a front chamber of FIG. 1.

FIG. 5 is a developed view illustrating a state in which the inner panel of FIG. 3 and the base panel of FIG. 4 are coupled to overlap each other.

FIG. 6 is a perspective view illustrating a front chamber of FIG. 1 in an inflated and deployed state.

FIG. 7 is a side view schematically illustrating a state in which the front chamber according to the first embodiment of the present disclosure is inflated and deployed in the event of a vehicle collision accident.

FIG. 8 is a perspective view illustrating an airbag apparatus in an inflated and deployed state according to a second embodiment of the present disclosure.

FIG. 9 is a front view schematically illustrating an interior of a seatback of FIG. 8.

FIG. 10 is a developed view illustrating an example of an inner panel and an outer panel included in a side chamber of FIG. 8.

FIG. 11 is a developed view illustrating an example of a base panel and a cover panel included in a front chamber of FIG. 8.

FIG. 12 is a developed view illustrating a state in which the inner panel of FIG. 10 and the base panel of FIG. 11 are coupled to overlap each other.

FIG. 13 is a perspective view illustrating a state in which the front chamber, formed by coupling the base panel and the cover panel of FIG. 11, is inflated and deployed.

FIG. 14 is a side view schematically illustrating a state in which the front chamber of FIG. 13 is inflated and deployed in the event of a vehicle collision accident.

FIG. 15 is a developed view illustrating an example of a base panel and a cover panel included in a front chamber of an airbag apparatus according to a third embodiment of the present disclosure.

FIG. 16 is a perspective view illustrating a state in which the front chamber, formed by coupling the base panel and the cover panel of FIG. 15, is inflated and deployed.

### DETAILED DESCRIPTION

Hereinafter, an airbag apparatus according to an embodiment of the present disclosure will be described in detail with reference to the accompanying drawings. The terminology used herein is for the purpose of describing particular embodiments and may vary according to the intention of users or operators or conventional custom in the art. Accordingly, definition of the terminology should be made according to the overall disclosure set forth herein.

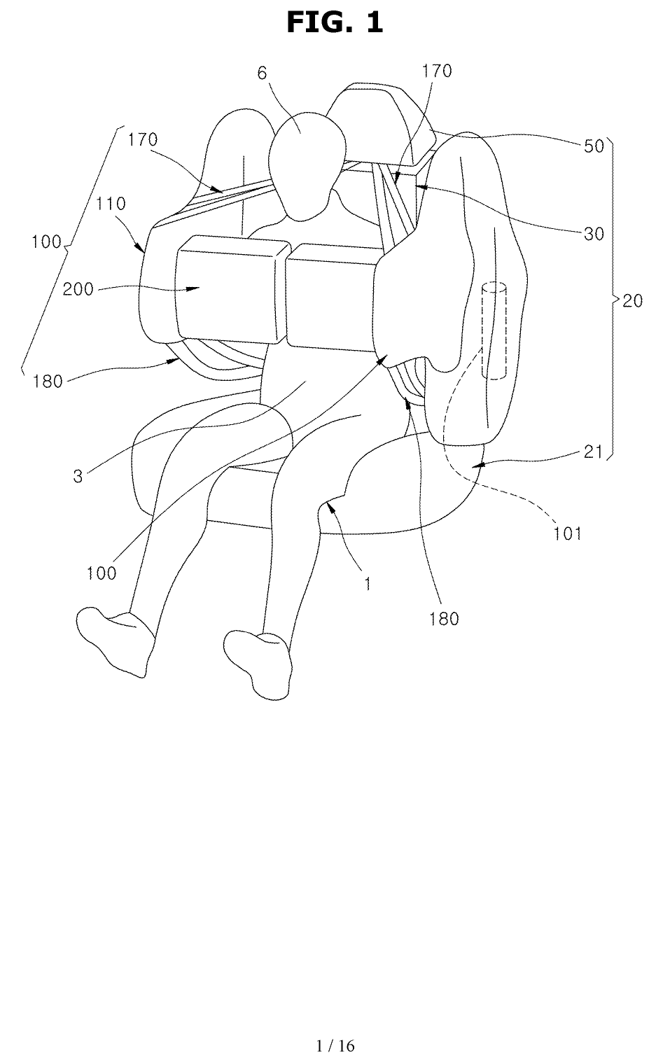

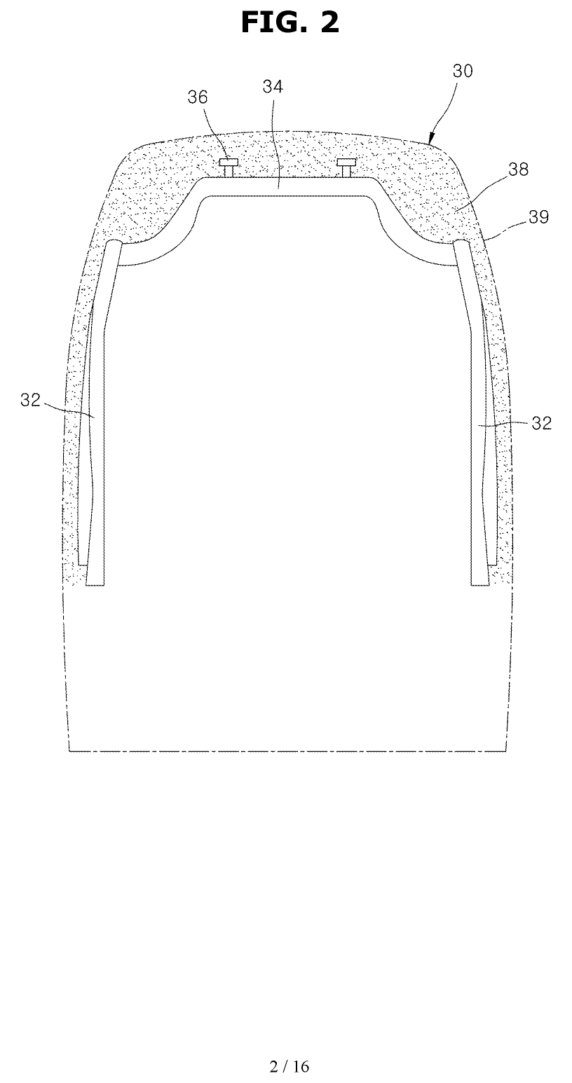

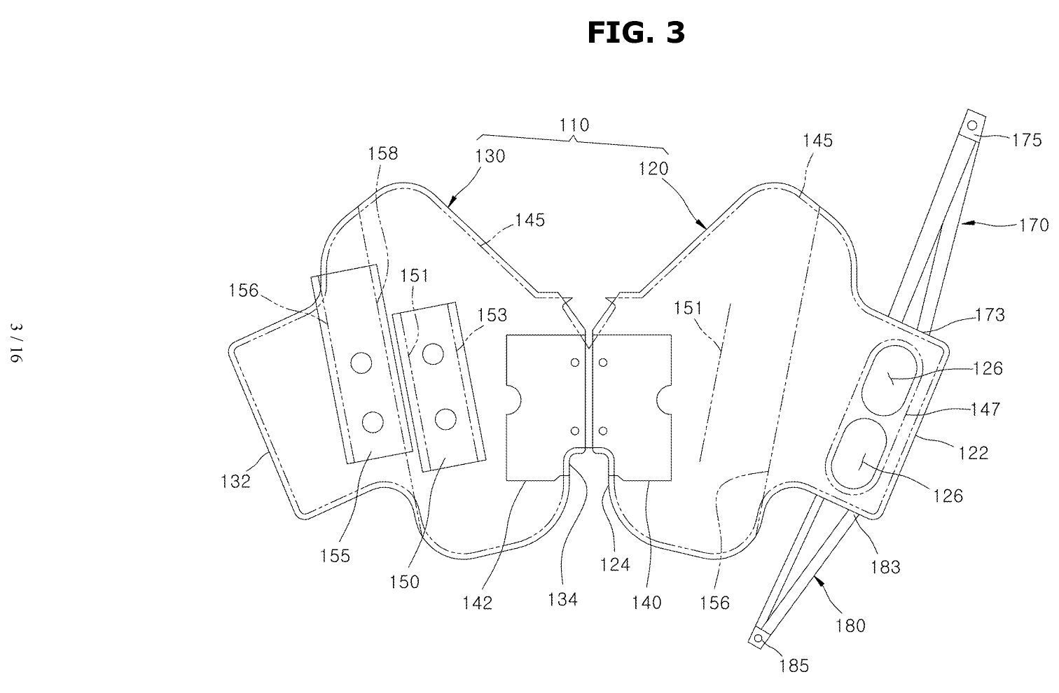

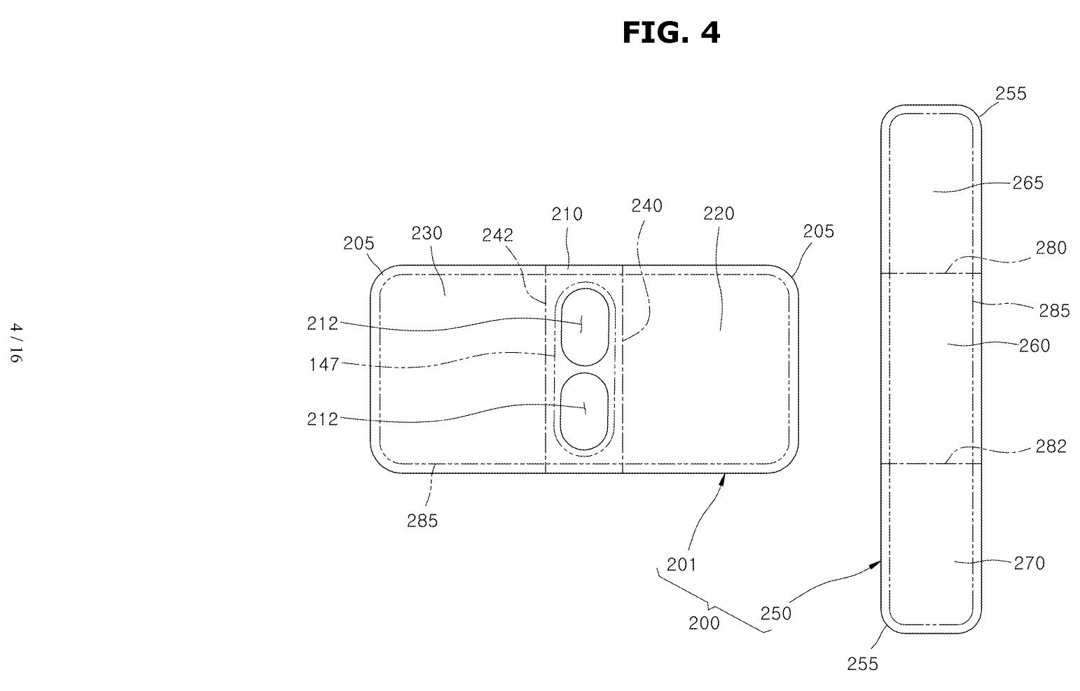

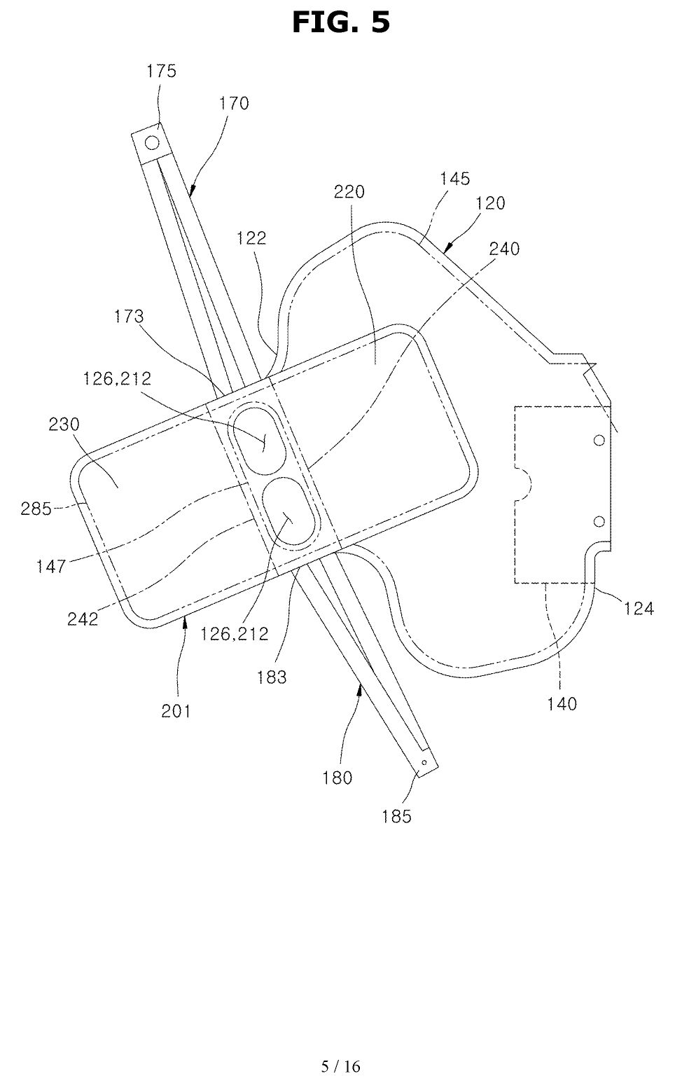

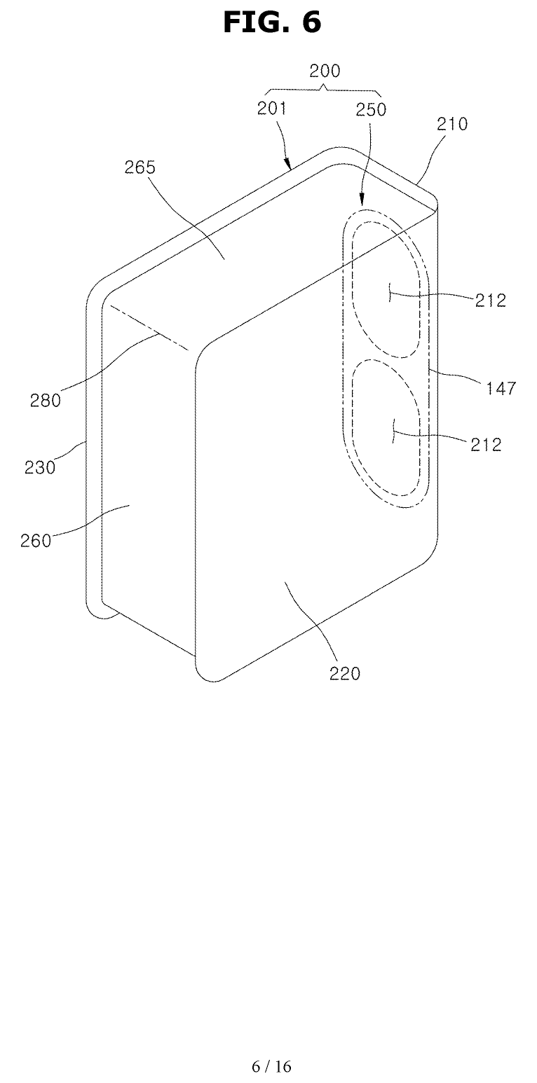

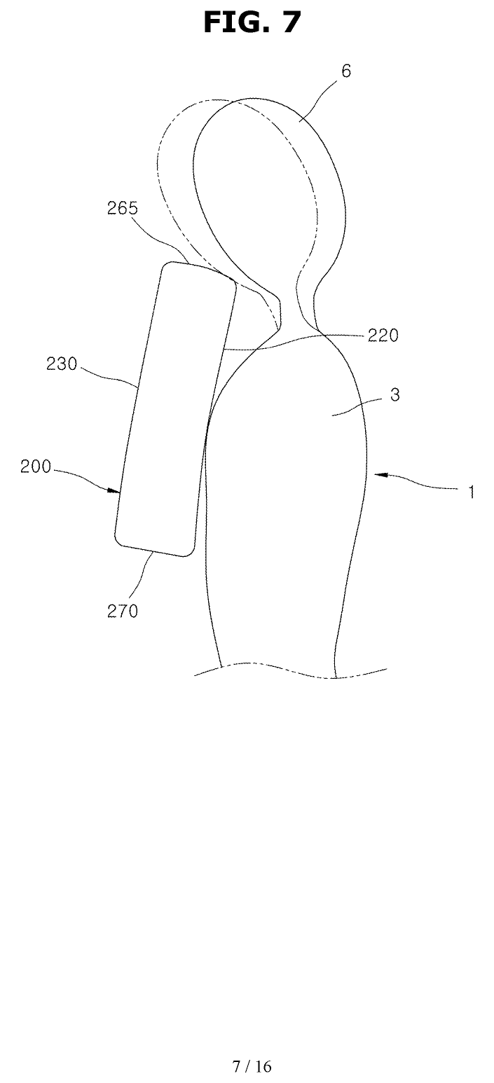

FIG. 1 is a perspective view illustrating an airbag apparatus in an inflated and deployed state according to a first embodiment of the present disclosure. FIG. 2 is a front view schematically illustrating an interior of a seatback of FIG. 1. FIG. 3 is a developed view illustrating an example of an inner panel and an outer panel included in a side chamber of FIG. 1. FIG. 4 is a developed view illustrating an example of a base panel and a cover panel included in a front chamber of FIG. 1. FIG. 5 is a developed view illustrating a state in which the inner panel of FIG. 3 and the base panel of FIG. 4 are coupled to overlap each other. FIG. 6 is a perspective view illustrating a front chamber of FIG. 1 in an inflated and deployed state. FIG. 7 is a side view schematically illustrating a state in which the front chamber is inflated and deployed in the event of a vehicle collision accident.

Referring to FIGS. 1 and 2, an airbag apparatus 100 according to an embodiment of the present disclosure may include a side chamber 110 and a front chamber 200. As illustrated in FIG. 1, a pair of airbag apparatuses 100 may be respectively disposed on left and right sides of a seat 20. Unlike the illustration in FIG. 1, only one airbag apparatus 100 may be disposed on one of the left and right sides of the seat 20.

The seat 20 of a vehicle may include a seat stool 21 that supports buttocks of a seated occupant 1, a seatback 30 that supports a back of the seated occupant 1, and a headrest 50 that supports a head of the seated occupant 1.

The seatback 30 may include seatback frames 32 and 34. The seatback frames 32 and 34 may include a pair of side frames 32 spaced apart from each other in a left-right direction, and an upper frame 34 connected to upper portions of the pair of side frames 32. The side frames 32 and the upper frame 34 may be formed of a metallic material, e.g., stainless steel.

The upper frame 34 may include a headrest holder 36. A headrest pin (not shown), which is provided to couple the headrest 50 to the seatback 30, may be detachably coupled to the headrest holder 36.

The seatback 30 may further include an outer covering 39 that encloses the seatback frames 32 and 34, and a cushion 38 that is disposed inside the outer covering 39 to alleviate impact to the seated occupant.

A tearable tear line (not shown) may be formed in the outer covering 39. When the side chamber 110 and the front chamber 200 are inflated and deployed due to a vehicle collision accident, the outer covering 39 may be ruptured along the tear line by at least one of the side chamber 110 or the front chamber 200.

The airbag apparatus 100 may further include an inflator 101. The inflator 101 may provide gas to inflate and deploy the side chamber 110 and the front chamber 200 in the event of a vehicle collision accident.

The inflator 101 may be located inside the side chamber 110. As illustrated in FIG. 1, in the case where the pair of airbag apparatuses 100 are respectively provided on opposite sides of the seatback 30, a pair of inflators 101 may be provided to correspond one-to-one with the pair of airbag apparatuses 100.

The inflator 101 may include an inflator body, and a fixing stud (not shown) configured to fix and couple the inflator body to a first side of the seatback 30, for example, to a lower portion of the corresponding side frame 32. Because the inflator 101 is supported by the seatback 30 in the foregoing manner, the side chamber 110 and the front chamber 200 may be supported by the seatback 30.

In a non-deployed state of the side chamber 110 and the front chamber 200, the side chamber 110, the front chamber 200, and the inflator 101 are located inside the outer covering 39 so as not to be exposed outside the seatback 30. In this state, the side chamber 110 and the front chamber 200 are located inside the outer covering 39 in a folded and non-inflated state.

Referring to FIGS. 1 to 7, the side chamber 110 may be disposed at (or installed in) the seatback 30 and may be deployed to protrude from a lateral side of the seatback 30 and face a lateral side of the seated occupant 1 in the seat 20. For example, the side chamber 110 may be deployed to protrude forward from a right side of the seatback 30 and face a right side of the seated occupant 1. Alternatively, the side chamber 110 may be deployed to protrude forward from a left side of the seatback 30 and face a left side of the seated occupant 1. The side chamber 110 may block a lateral side of an upper body 3 of the seated occupant 1 in the event of a vehicle collision accident to protect the seated occupant 1.

The front chamber 200 may be connected to the side chamber 110 to allow gas to flow therebetween, and may be deployed to protrude in a direction bent from the side chamber 110 and face a front surface of the seated occupant 1. In the event of a vehicle collision accident, the front chamber 200 may block a front side of the upper body 3 of the seated occupant 1 to protect the seated occupant 1.

The side chamber 110 may include an inner panel 120 and an outer panel 130. The inner panel 120 may be facing (or positioned to face) the seated occupant 1. The outer panel 130 is positioned to face away from the seated occupant 1 with the inner panel 120 interposed therebetween. FIG. 3 illustrates inner surfaces of the inner panel 120 and the outer panel 130.

An internal space of the side chamber 110 may be defined by the inner panel 120 and the outer panel 130 that overlaps the inner panel 120. The side chamber 110 may be formed by overlapping the inner panel 120 and the outer panel 130 and sewing outer peripheral portions of the inner panel 120 and the outer panel 130 along an outer sewing line 145.

A rear end of the side chamber 110 may be formed by overlapping and sewing a rear end 124 of the inner panel 120 and a rear end 134 of the outer panel 130. A front end of the side chamber 110 may be formed by overlapping and sewing a front end 122 of the inner panel 120 and a front end 132 of the outer panel 130.

In order to prevent the side chamber 110 from being damaged due to heat and pressure of gas discharged when the inflator 101 explodes due to a vehicle collision accident, an inflator mounting panel 140 may be attached to the rear end 124 of the inner panel 120, and an inflator mounting panel 142 may be attached to the rear end 134 of the outer panel 130. The rear end 124 of the inner panel 120, the rear end 134 of the outer panel 130, and the inflator mounting panels 140 and 142 may be sewn together along a sewing line (not shown), and the inflator 101 may be installed therein.

The side chamber 110 may include at least a first side chamber internal tether 150 and/or 155 in the side chamber 110 to limit a thickness of the side chamber 110. For example, the side chamber 110 may include a first side chamber internal tether 150 and a second side chamber internal tether 155 that is located in front of the first side chamber internal tether 150.

One end of the first side chamber internal tether 150 may be sewn along a sewing line 151 and coupled to the inner panel 120. A remaining end of the first side chamber internal tether 150 may be sewn along a sewing line 153 and coupled to the outer panel 130.

One end of the second side chamber internal tether 155 may be sewn along a sewing line 156 and coupled to the inner panel 120. A remaining end of the second side chamber internal tether 155 may be sewn along a sewing line 158 and coupled to the outer panel 130. A tether through-hole may be formed in each of the side chamber internal tethers 150 and 155 to allow gas to smoothly flow when the side chamber 110 is deployed.

The airbag apparatus 100 may further include an upper tether 170 and a lower tether 180. The upper tether 170 may connect an upper portion of the seatback 30 and the front end of the side chamber 110.

For example, a first end 173 of the upper tether 170 may be coupled to an upper portion of the front end 122 of the inner panel 120 by sewing. A second end 175 of the upper tether 170 may be coupled to the headrest holder 36 or the headrest pin.

The lower tether 180 may connect one of a left side portion and a right-side portion of the seatback 30 to the front end of the side chamber 110. For example, a first end 183 of the lower tether 180 may be coupled to a lower portion of the front end 122 of the inner panel 120 by sewing. A second end 185 of the lower tether 180 may be coupled to a lower portion of the side frame 32.

The outer covering 39 may include a tearable tear line (not shown) that allows the upper tether 170 and the lower tether 180 to protrude outward from the seatback 30. When the side chamber 110 and the front chamber 200 are inflated and deployed due to a vehicle collision accident, the upper tether 170 and the lower tether 180 may be pulled by the expanding side chamber 110, and the seatback 30 may be ruptured along the tear line, so that the upper tether 170 and the lower tether 180 may be deployed as illustrated in FIG. 1.

The front chamber 200 may include a base panel 201 coupled to the side chamber 110, and a cover panel 250 coupled to an outer peripheral portion of the base panel 201.

The base panel 201 may include a first base portion 210, a second base portion 220, and a third base portion 230. The first base portion 210 may be located to face the inner panel 120 of the side chamber 110.

FIG. 5 illustrates an outer surface of the inner panel 120. The first base portion 210 may be disposed to overlap the outer surface of the front end 122 of the inner panel 120. As illustrated in FIG. 7, the second base portion 220 may be located to face the seated occupant. The second base portion 220 may be bent along a first base bending line 240 from a first side of the first base portion 210 with respect to a width direction of the first base portion 210.

As illustrated in FIG. 7, the third base portion 230 may be located to face away from the seated occupant 1 with the second base portion 220 interposed therebetween. The third base portion 230 may be bent along a second base bending line 242 from a second side of the first base portion 210 with respect to the width direction of the first base portion 210. The first base portion 210 may be interposed between the second base portion 220 and the third base portion 230.

The cover panel 250 may include a first cover portion 260, a second cover portion 265, and a third cover portion 270. The first cover portion 260 may be spaced apart from the first base portion 210, and may be positioned to face the first base portion 210.

The second cover portion 265 may be bent along a first cover bending line 280 from a first side of the first cover portion 260 with respect to a longitudinal direction of the first cover portion 260. The second cover portion 265 may be positioned above the first cover portion 260.

The third cover portion 270 may be bent along a second cover bending line 282 from a second side of the first cover portion 260 with respect to the longitudinal direction of the first cover portion 260. The third cover portion 270 may be located below the first cover portion 260. The first cover portion 260 may be interposed between the second cover portion 265 and the third cover portion 270.

The front chamber 200 may be formed by sewing an outer peripheral portion of the base panel 201 and an outer peripheral portion of the cover panel 250 along an outer sewing line 285. In a deployed state of the front chamber 200, the front chamber 200 may have a rectangular parallelepiped shape as illustrated in FIG. 6. For example, the shape of the front chamber 200 may correspond to that of a thick book with a hard cover.

The first base portion 210 and the first cover portion 260 may extend in a vertical direction. A width of the first base portion 210 may be the same as that of the first cover portion 260. A width direction of the first base portion 210 may be perpendicular to the vertical direction and also perpendicular to a thickness direction of the base panel 201. A width direction of the first cover portion 260 may be perpendicular to the vertical direction and also perpendicular to a thickness direction of the cover panel 250.

The width of the first base portion 210 may be constant along a longitudinal direction of the first base portion 210. The width of the first cover portion 260 may be constant along a longitudinal direction of the first cover portion 260.

The longitudinal direction of the first base portion 210 may be perpendicular to a longitudinal direction of the base panel 201 that is in an unfolded state. The width direction of the first base portion 210 may be the same as the longitudinal direction of the base panel 201 that is in an unfolded state. The longitudinal direction of the first cover portion 260 may be the same as a longitudinal direction of the cover panel 250 that is in an unfolded state.

In a state where the base panel 201 and the cover panel 250 are not coupled and are unfolded, a planar shape of the base panel 201 may be a rectangular shape with four rounded corners 205, as illustrated in FIG. 4, or a rectangular shape.

Similarly, in a state where the base panel 201 and the cover panel 250 are not coupled and are unfolded, a planar shape of the cover panel 250 may be a rectangular shape with four rounded corners 255, as illustrated in FIG. 4, or a rectangular shape.

Referring to FIGS. 4 and 6, in a state where the base panel 201 and the cover panel 250 are coupled, outer peripheral portions of the second cover portion 265 and the third cover portion 270 may be coupled to opposite widthwise ends of the base panel 201 by sewing. Opposite widthwise ends of the first cover portion 260 may be coupled to opposite longitudinal ends of the base panel 201 by sewing.

Although not illustrated in the drawings, the front chamber 200 may include at least one front chamber internal tether configured to limit a thickness of the front chamber 200. One end of the front chamber internal tether may be coupled to the second base portion 220 by sewing, and a remaining end of the front chamber internal tether may be coupled to the third base portion 230 by sewing.

In order to allow gas supplied from the inflator 101 to flow between the side chamber 110 and the front chamber 200, the inner panel 120 of the side chamber 110 and the base panel 201 of the front chamber 200 may respectively include through-holes 126 and 212 that are aligned with each other. For example, a front chamber connection through-hole 126 may be formed in the front end 122 of the inner panel 120, and a side chamber connection through-hole 212 may be formed in the first base portion 210 of the base panel 201.

To prevent gas from leaking between the inner panel 120 and the base panel 201, a hole-defining portion of the inner panel 120 surrounding the through-hole 126 and a hole-defining portion of the base panel 201 surrounding the through-hole 212 may be sewn together. For example, the first base portion 210 may be coupled to the front end 122 of the inner panel 120 by sewing, along a sewing line 147, the hole-defining portion provided around the front chamber connection through-hole 126 in the inner panel 120 and the hole-defining portion provided around the side chamber connection through-hole 212 in the first base portion 210.

According to the airbag apparatus 100 described above, in the event of a vehicle collision accident, gas may rapidly flow from the side chamber 110 to the front chamber 200 without blockage, so that the side chamber 110 and the front chamber 200 may be smoothly deployed to block the lateral side and front side of the seated occupant 1.

In the airbag apparatus 100, a thickness of an upper portion of the front chamber 200 may be stably maintained by the second cover portion 265 of the cover panel 250 interposed between the second base portion 220 and the third base portion 230 of the base panel 201. Accordingly, in the event of a vehicle collision accident, the upper portion of the front chamber 200 may firmly support the neck and head 6 of the seated occupant 1, thereby preventing serious injury to the neck and head 6 of the seated occupant 1.

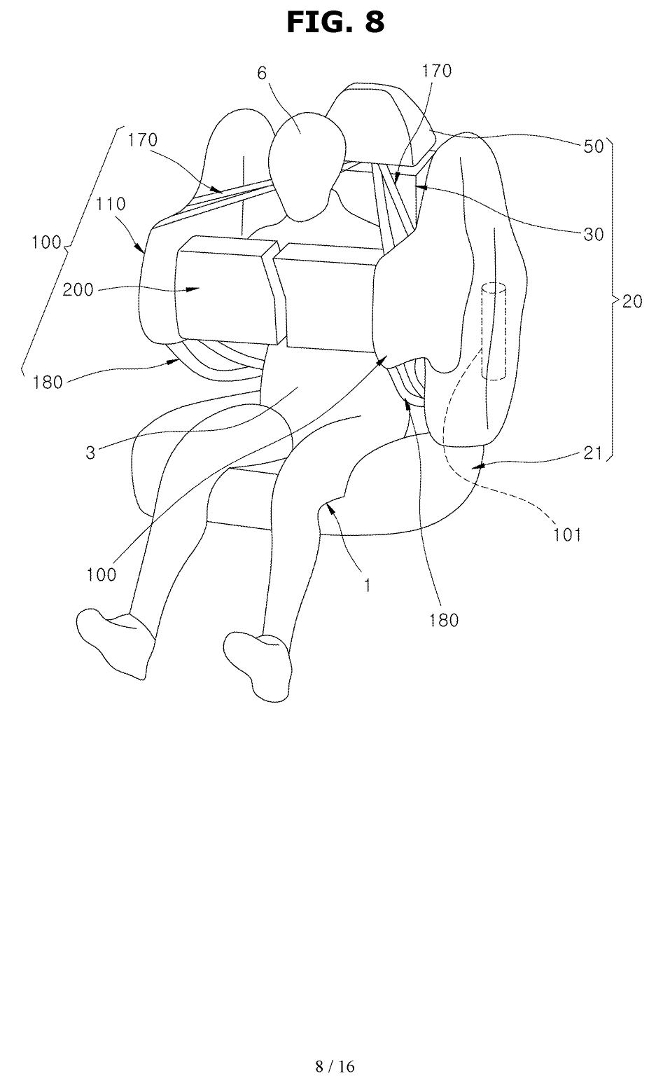

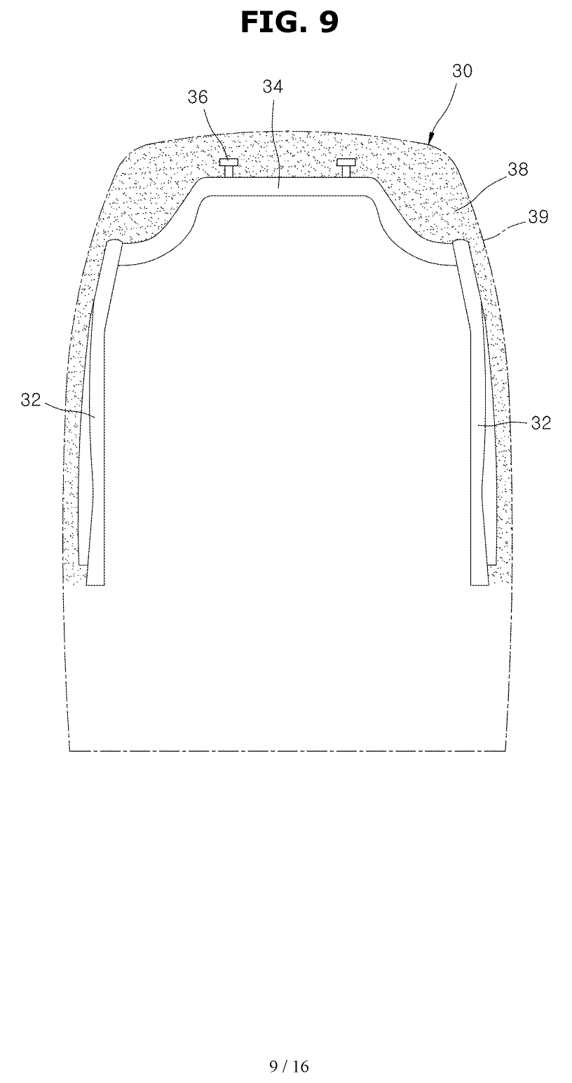

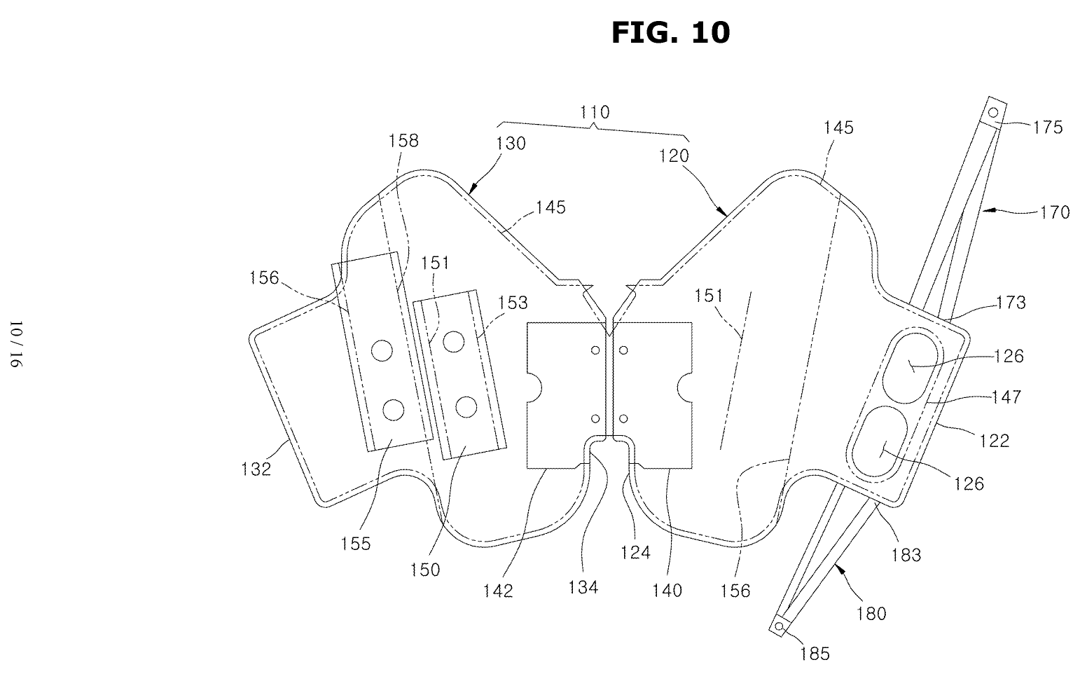

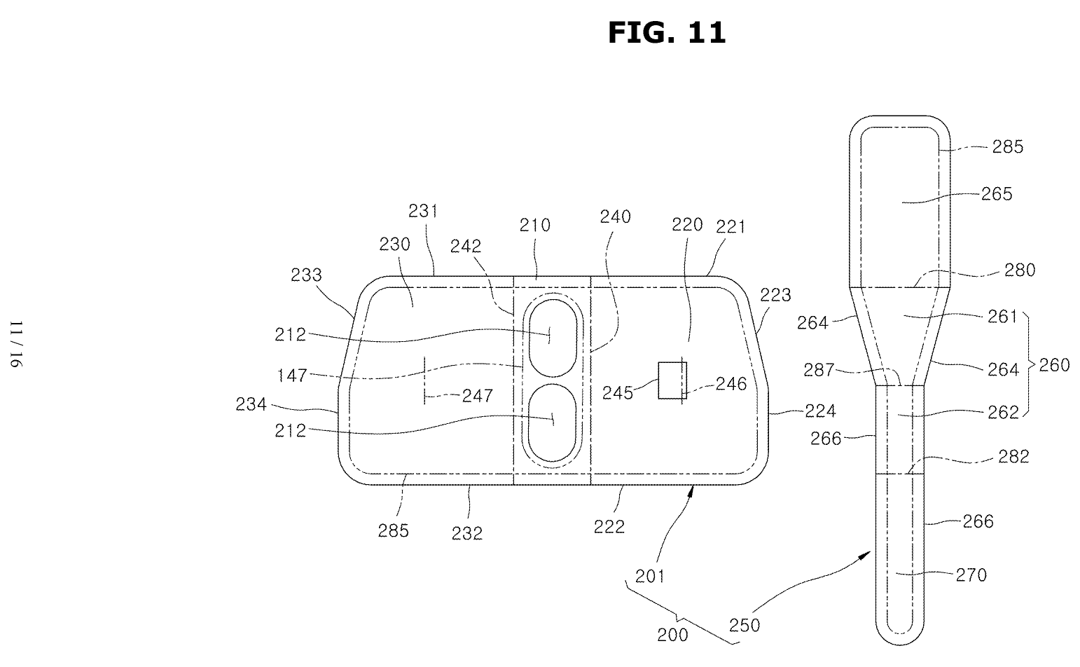

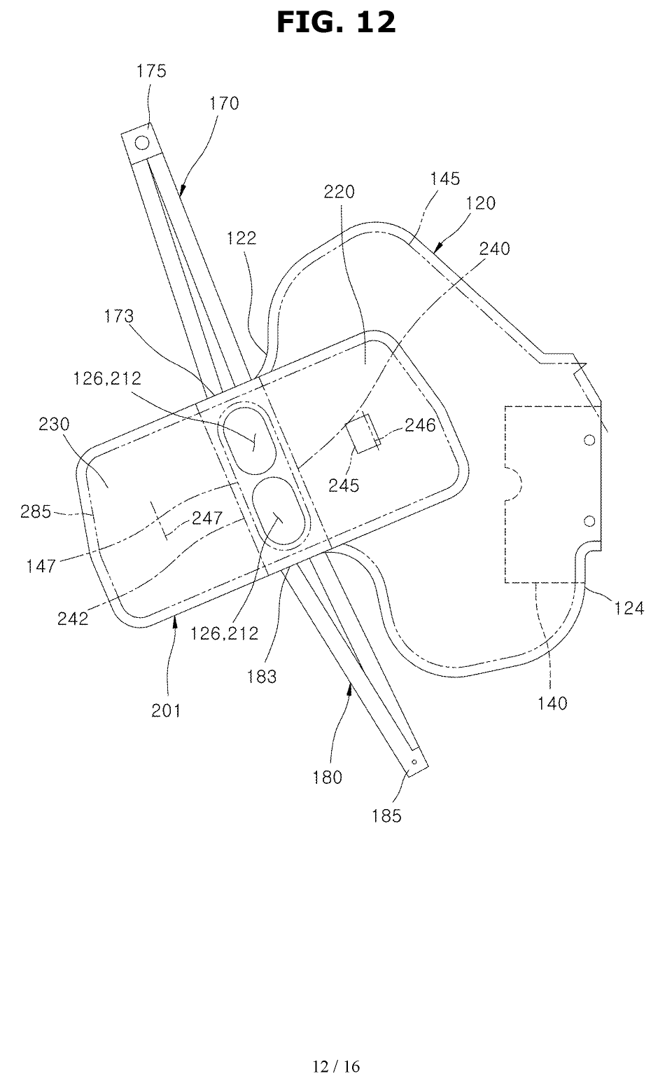

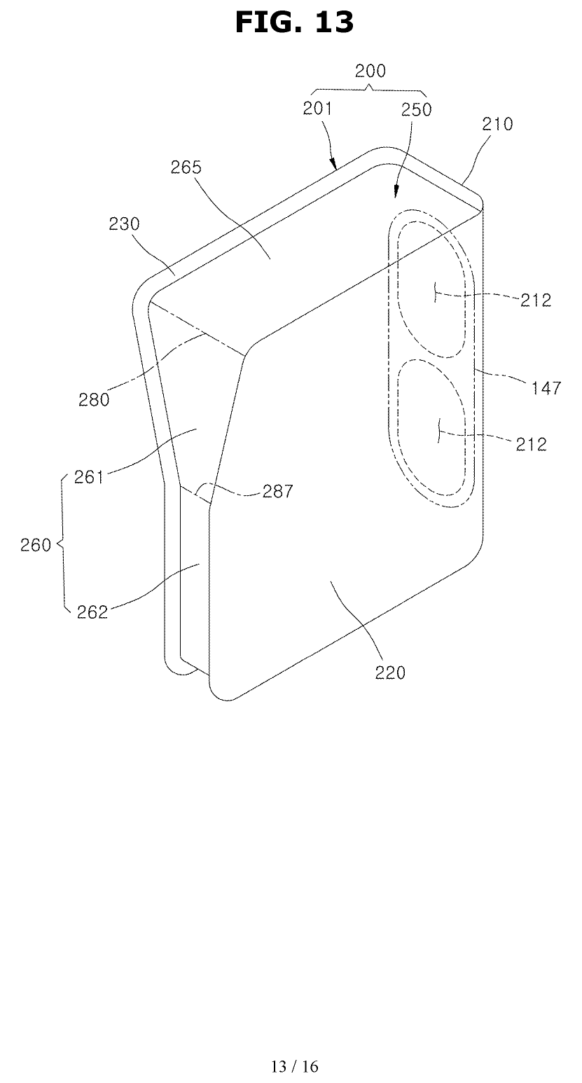

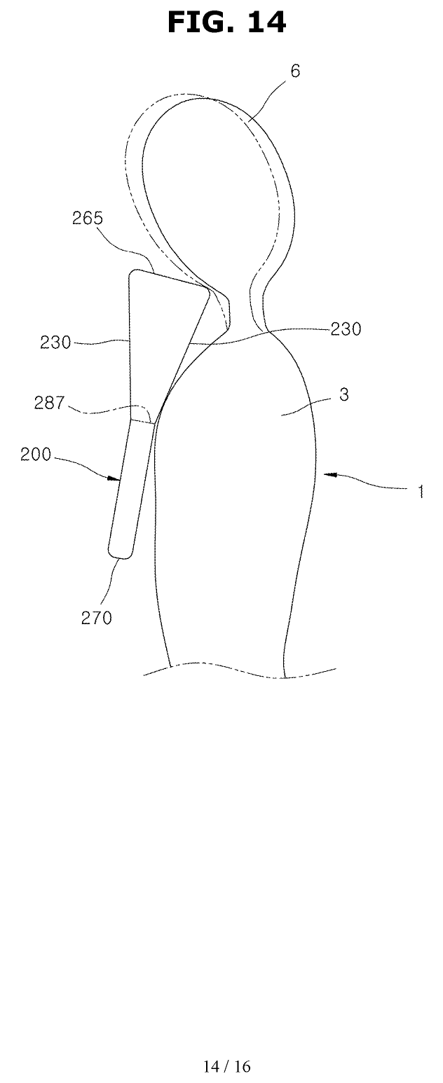

FIG. 8 is a perspective view illustrating an airbag apparatus in an inflated and deployed state according to a second embodiment of the present disclosure. FIG. 9 is a front view schematically illustrating an interior of a seatback of FIG. 8. FIG. 10 is a developed view illustrating an example of an inner panel and an outer panel included in a side chamber of FIG. 8. FIG. 11 is a developed view illustrating an example of a base panel and a cover panel included in a front chamber of FIG. 8. FIG. 12 is a developed view illustrating a state in which the inner panel of FIG. 10 and the base panel of FIG. 11 are coupled to overlap each other. FIG. 13 is a perspective view illustrating a state in which the front chamber, formed by coupling the base panel and the cover panel of FIG. 11, is inflated and deployed. FIG. 14 is a side view schematically illustrating a state in which the front chamber of FIG. 13 is inflated and deployed in the event of a vehicle collision accident.

Referring to FIGS. 8 and 9, an airbag apparatus 100 according to the second embodiment of the present disclosure may include a side chamber 110 and a front chamber 200. As illustrated in FIG. 8, a pair of airbag apparatuses 100 may be respectively disposed on left and right sides of a seat 20. Unlike the illustration in FIG. 8, only one airbag apparatus 100 may be disposed on one of the left and right sides of the seat 20.

The seat 20 of a vehicle may include a seat stool 21 that supports buttocks of a seated occupant 1, a seatback 30 that supports a back of the seated occupant 1, and a headrest 50 that supports a head of the seated occupant 1.

The seatback 30 may include seatback frames 32 and 34. The seatback frames 32 and 34 may include a pair of side frames 32 spaced apart in a left-right direction, and an upper frame 34 connected to upper portions of the pair of side frames 32. The side frames 32 and the upper frame 34 may be formed of a metallic material, e.g., stainless steel.

The upper frame 34 may include a headrest holder 36. A headrest pin (not shown), which is provided to couple the headrest 50 to the seatback 30, may be detachably coupled to the headrest holder 36.

The seatback 30 may further include an outer covering 39 that encloses the seatback frames 32 and 34, and a cushion 38 that is disposed inside the outer covering 39 to alleviate impact to the seated occupant.

A tearable tear line (not shown) may be formed in the outer covering 39. When the side chamber 110 and the front chamber 200 are inflated and deployed due to a vehicle collision accident, the outer covering 39 may be ruptured along the tear line by at least one of the side chamber 110 or the front chamber 200.

The airbag apparatus 100 may further include an inflator 101. The inflator 101 may provide gas to inflate and deploy the side chamber 110 and the front chamber 200 in the event of a vehicle collision accident.

The inflator 101 may be located inside the side chamber 110. As illustrated in FIG. 8, in the case where the pair of airbag apparatuses 100 are respectively provided on opposite sides of the seatback 30, a pair of inflators 101 may be provided to correspond one-to-one with the pair of airbag apparatuses 100.

The inflator 101 may include an inflator body, and a fixing stud (not shown) configured to fix and couple the inflator body to a first side of the seatback 30, for example, to a lower portion of the corresponding side frame 32. Because the inflator 101 is supported by the seatback 30 in the foregoing manner, the side chamber 110 and the front chamber 200 may be supported by the seatback 30.

In a non-deployed state of the side chamber 110 and the front chamber 200, the side chamber 110, the front chamber 200, and the inflator 101 are located inside the outer covering 39 so as not to be exposed outside the seatback 30. In this state, the side chamber 110 and the front chamber 200 are located inside the outer covering 39 in a folded and non-inflated state.

Referring to FIGS. 8 to 14, the side chamber 110 may be disposed at (or installed in) the seatback 30 and may be deployed to protrude from a lateral side of the seatback 30 and face a lateral side of the seated occupant 1 in the seat 20. For example, the side chamber 110 may be deployed to protrude forward from a right side of the seatback 30 and face a right side of the seated occupant 1. Alternatively, the side chamber 110 may be deployed to protrude forward from a left side of the seatback 30 and face a left side of the seated occupant 1. The side chamber 110 may block a lateral side of an upper body 3 of the seated occupant 1 in the event of a vehicle collision accident to protect the seated occupant 1.

The front chamber 200 may be connected to the side chamber 110 to allow gas to flow therebetween, and may be deployed to protrude in a direction bent from the side chamber 110 and face a front surface of the seated occupant 1. In the event of a vehicle collision accident, the front chamber 200 may block a front side of the upper body 3 of the seated occupant 1 to protect the seated occupant 1.

The side chamber 110 may include an inner panel 120 and an outer panel 130. The inner panel 120 may be positioned to face the seated occupant 1. The outer panel 130 may be positioned to face away from the seated occupant 1 with the inner panel 120 interposed therebetween. FIG. 10 illustrates inner surfaces of the inner panel 120 and the outer panel 130.

An internal space of the side chamber 110 may be defined by the inner panel 120 and the outer panel 130 that overlaps the inner panel 120. The side chamber 110 may be formed by overlapping the inner panel 120 and the outer panel 130 and sewing outer peripheral portions of the inner panel 120 and the outer panel 130 along an outer sewing line 145.

A rear end of the side chamber 110 may be formed by overlapping and sewing a rear end 124 of the inner panel 120 and a rear end 134 of the outer panel 130. A front end of the side chamber 110 may be formed by overlapping and sewing a front end 122 of the inner panel 120 and a front end 132 of the outer panel 130.

In order to prevent the side chamber 110 from being damaged due to heat and pressure of gas discharged when the inflator 101 explodes due to a vehicle collision accident, an inflator mounting panel 140 may be attached to the rear end 124 of the inner panel 120, and an inflator mounting panel 142 may be attached to the rear end 134 of the outer panel 130. The rear end 124 of the inner panel 120, the rear end 134 of the outer panel 130, and the inflator mounting panels 140 and 142 may be sewn together along a sewing line (not shown), and the inflator 101 may be installed therein.

The side chamber 110 may include at least a first side chamber internal tether 150 and/or 155 in the side chamber 110 to limit a thickness of the side chamber 110. For example, the side chamber 110 may include a first side chamber internal tether 150 and a second side chamber internal tether 155 that is located in front of the first side chamber internal tether 150.

One end of the first side chamber internal tether 150 may be sewn along a sewing line 151 and coupled to the inner panel 120. A remaining end of the first side chamber internal tether 150 may be sewn along a sewing line 153 and coupled to the outer panel 130.

One end of the second side chamber internal tether 155 may be sewn along a sewing line 156 and coupled to the inner panel 120. A remaining end of the second side chamber internal tether 155 may be sewn along a sewing line 158 and coupled to the outer panel 130. A tether through-hole may be formed in each of the side chamber internal tethers 150 and 155 to allow smooth flow of gas when the side chamber 110 is deployed.

The airbag apparatus 100 may further include an upper tether 170 and a lower tether 180. The upper tether 170 may connect an upper portion of the seatback 30 and the front end of the side chamber 110.

For example, a first end 173 of the upper tether 170 may be coupled to an upper portion of the front end 122 of the inner panel 120 by sewing. A second end 175 of the upper tether 170 may be coupled to the headrest holder 36 or the headrest pin.

The lower tether 180 may connect one of a left side portion and a right-side portion of the seatback 30 to the front end of the side chamber 110. For example, a first end 183 of the lower tether 180 may be coupled to a lower portion of the front end 122 of the inner panel 120 by sewing. A second end 185 of the lower tether 180 may be coupled to a lower portion of the side frame 32.

The outer covering 39 may include a tearable tear line (not shown) that allows the upper tether 170 and the lower tether 180 to protrude outward from the seatback 30. When the side chamber 110 and the front chamber 200 are inflated and deployed due to a vehicle collision accident, the upper tether 170 and the lower tether 180 may be pulled by the expanding side chamber 110, and the seatback 30 may be ruptured along the tear line, so that the upper tether 170 and the lower tether 180 may be deployed as illustrated in FIG. 8.

The front chamber 200 may include a base panel 201 coupled to the side chamber 110, and a cover panel 250 coupled to an outer peripheral portion of the base panel 201.

The base panel 201 may include a first base portion 210, a second base portion 220, and a third base portion 230. The first base portion 210 may be located to face the inner panel 120 of the side chamber 110.

FIG. 12 illustrates an outer surface of the inner panel 120. The first base portion 210 may be disposed to overlap the outer surface of the front end 122 of the inner panel 120. As illustrated in FIG. 14, the second base portion 220 may be located to face the seated occupant. The second base portion 220 may be bent along a first base bending line 240 from a first side of the first base portion 210 with respect to a width direction of the first base portion 210.

As illustrated in FIG. 14, the third base portion 230 may be located to face away from the seated occupant 1 with the second base portion 220 interposed therebetween. The third base portion 230 may be bent along a second base bending line 242 from a second side of the first base portion 210 with respect to the width direction of the first base portion 210. The first base portion 210 may be interposed between the second base portion 220 and the third base portion 230.

The cover panel 250 may include a first cover portion 260, a second cover portion 265, and a third cover portion 270. The first cover portion 260 may be spaced apart from the first base portion 210, and may be positioned to face the first base portion 210.

The second cover portion 265 may be bent along a first cover bending line 280 from a first side of the first cover portion 260 with respect to a longitudinal direction of the first cover portion 260. The second cover portion 265 may be positioned above the first cover portion 260.

The third cover portion 270 may be bent along a second cover bending line 282 from a second side of the first cover portion 260 with respect to the longitudinal direction of the first cover portion 260. The third cover portion 270 may be located below the first cover portion 260. The first cover portion 260 may be interposed between the second cover portion 265 and the third cover portion 270. The front chamber 200 may be formed by sewing an outer peripheral portion of the base panel 201 and an outer peripheral portion of the cover panel 250 along an outer sewing line 285.

The first cover portion 260 may include a tapered portion 261 and a narrow-width portion 262. The tapered portion 261 may have a width increasing from an intermediate point between an upper end and a lower end of the first cover portion 260 toward the upper end of the first cover portion 260. A planar shape of the tapered portion 261 may be a trapezoidal shape.

The narrow-width portion 262 may extend from the intermediate point of the first cover portion 260 to the lower end thereof, with a width identical to a width of the tapered portion 261. The width of the narrow-width portion 262 may be the same as a minimum width of the tapered portion 261. For example, the width of the narrow-width portion 262 may be the same as a width of the tapered portion 261 at a boundary point between the tapered portion 261 and the narrow-width portion 262.

In a state in which the front chamber 200 is inflated and deployed, a height of the upper end of the first cover portion 260 may be equal to a height of the first cover bending line 280, and a height of the lower end of the first cover portion 260 may be equal to a height of the second cover bending line 282.

A height of the intermediate point between the upper end and the lower end of the first cover portion 260 may be the same as a height of a boundary line 287 between the tapered portion 261 and the narrow-width portion 262. The boundary line 287 may be an imaginary line extending in parallel with the width direction of the first cover portion 260 at a center point with respect to the longitudinal direction of the first cover portion 260.

A width of the second cover portion 265 may be the same as a width of the tapered portion 261 at a boundary point between the first cover portion 260 and the second cover portion 265, that is, at the first cover bending line 280. The second cover portion 265 may extend with a constant width along a longitudinal direction of the cover panel 250.

A width of the third cover portion 270 may be the same as the width of the narrow-width portion 262. The third cover portion 270 may extend with a constant width along the longitudinal direction of the cover panel 250.

The tapered portion 261 may include a pair of inclined cover edges 264 that are inclined at opposite widthwise ends of the cover panel 250. The narrow-width portion 262 may include a pair of parallel cover edges 266 that are parallel to each other at opposite widthwise ends of the cover panel 250.

The second base portion 220 and the third base portion 230 may respectively include a pair of inclined base edges 223 and 233 corresponding to the pair of inclined cover edges 264, and may respectively include a pair of parallel base edges 224 and 234 corresponding to the pair of parallel cover edges 266.

The pair of inclined base edges 223 and 233 and the pair of parallel base edges 224 and 234 may be provided at opposite longitudinal ends of the base panel 201 that is in an unfolded state.

The width direction of the first base portion 210 may be a direction perpendicular to the vertical direction and also perpendicular to the thickness direction of the base panel 201. The width direction of the first cover portion 260 may be a direction perpendicular to the vertical direction and also perpendicular to the thickness direction of the cover panel 250.

The longitudinal direction of the first base portion 210 may be perpendicular to a longitudinal direction of the base panel 201 that is in an unfolded state. The width direction of the first base portion 210 may be the same as the longitudinal direction of the base panel 201 that is in an unfolded state. The longitudinal direction of the first cover portion 260 may be the same as a longitudinal direction of the cover panel 250 that is in an unfolded state.

Referring to FIGS. 11 and 13, in a state where the base panel 201 and the cover panel 250 are coupled, outer peripheral portions of the second cover portion 265 and the third cover portion 270 may be coupled to opposite widthwise ends of the base panel 201 by sewing.

The pair of inclined cover edges 264 and the pair of parallel cover edges 266 of the first cover portion 260 may be coupled by sewing to the pair of inclined base edges 223 and 233 and the pair of parallel base edges 224 and 234 provided at opposite longitudinal ends of the base panel 201.

With the aforementioned configuration, a thickness of the upper portion of the front chamber 200 may be greater than that of an intermediate portion between the upper and lower portions of the front chamber 200. The thickness of the upper portion of the front chamber 200 may also be greater than that of the lower portion of the front chamber 200. A thickness of the front chamber 200 may be defined as a distance between the second base portion 220 and the third base portion 230 in a front-rear direction of the seated occupant 1 when the front chamber 200 is inflated.

The front chamber 200 may include at least one front chamber internal tether 245 to limit the thickness of the front chamber 200. One end of the front chamber internal tether 245 may be coupled to the second base portion 220 by sewing along a sewing line 246, and a remaining end of the front chamber internal tether 245 may be coupled to the third base portion 230 by sewing along a sewing line 247.

Unlike illustration in the drawings, a front chamber according to another embodiment of the present disclosure may include an upper front chamber internal tether, a lower front chamber internal tether, and an intermediate front chamber internal tether.

The upper front chamber internal tether may limit a thickness between an upper portion of the second base portion and an upper portion of the third base portion at a height corresponding to a height of the tapered portion. The lower front chamber internal tether may limit a thickness between a lower portion of the second base portion and a lower portion of the third base portion at a height corresponding to a height of the narrow-width portion. The intermediate front chamber internal tether may limit a thickness between an intermediate portion of the second base portion and an intermediate portion of the third base portion at a height of the boundary point between the tapered portion and the narrow-width portion.

To allow gas supplied from the inflator 101 to flow between the side chamber 110 and the front chamber 200, the inner panel 120 of the side chamber 110 and the base panel 201 of the front chamber 200 may respectively include through-holes 126 and 212 that are aligned with each other. For example, a front chamber connection through-hole 126 may be formed in a front end 122 of the inner panel 120, and a side chamber connection through-hole 212 may be formed in a first base portion 210 of the base panel 201.

To prevent gas from leaking between the inner panel 120 and the base panel 201, a hole-defining portion of the inner panel 120 surrounding the through-hole 126 and a hole-defining portion of the base panel 201 surrounding the through-hole 212 may be sewn together. For example, the first base portion 210 may be coupled to the front end 122 of the inner panel 120 by sewing, along a sewing line 147, the hole-defining portion provided around the front chamber connection through-hole 126 in the inner panel 120 and the hole-defining portion provided around the side chamber connection through-hole 212 in the first base portion 210.

According to the airbag apparatus 100 described above, in the event of a vehicle collision accident, gas may rapidly flow from the side chamber 110 to the front chamber 200 without blockage, so that the side chamber 110 and the front chamber 200 may be smoothly deployed to block the lateral side and front side of the seated occupant 1.

In the airbag apparatus 100, a thickness of the upper portion of the front chamber 200 may be stably maintained by the second cover portion 265 of the cover panel 250 interposed between the second base portion 220 and the third base portion 230 of the base panel 201. Accordingly, in the event of a vehicle collision accident, the upper portion of the front chamber 200 may firmly support the neck and head 6 of the seated occupant 1, thereby preventing serious injury to the neck and head 6 of the seated occupant 1.

The airbag apparatus 100 includes the front chamber 200 that is deployed to have a greater thickness in the upper portion thereof near the neck and the head 6 of the seated occupant 1 than in the intermediate portion thereof below the upper portion. Accordingly, a limited amount of gas discharged from the inflator 101 in the event of a vehicle collision accident may be effectively distributed inside the front chamber 200, and injury to the neck and the head 6 of the seated occupant 1 may be more reliably prevented.

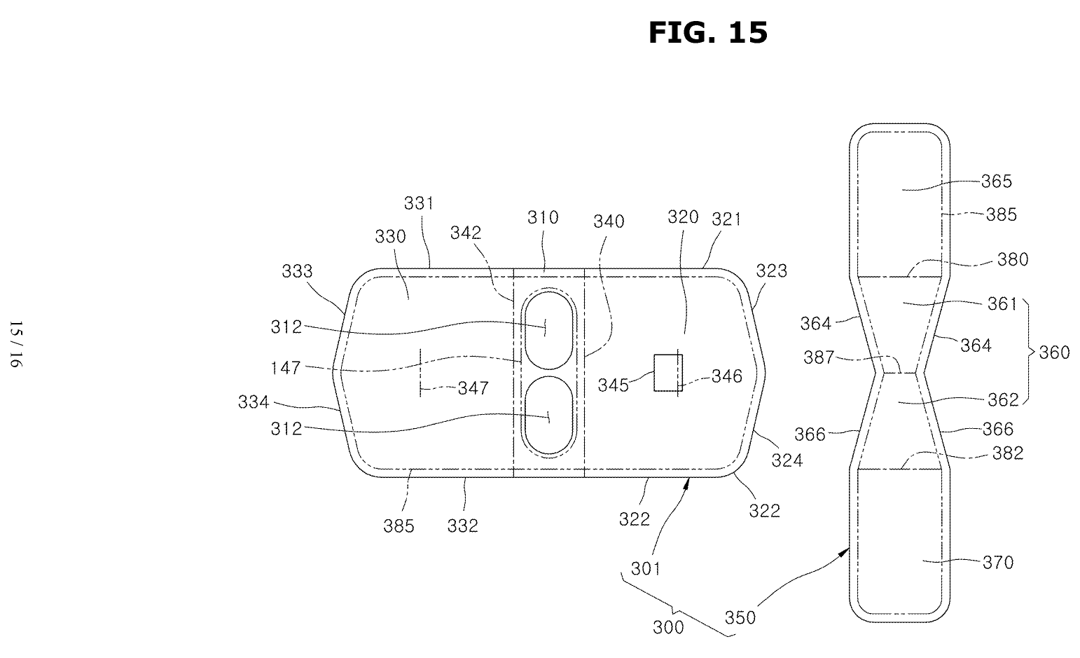

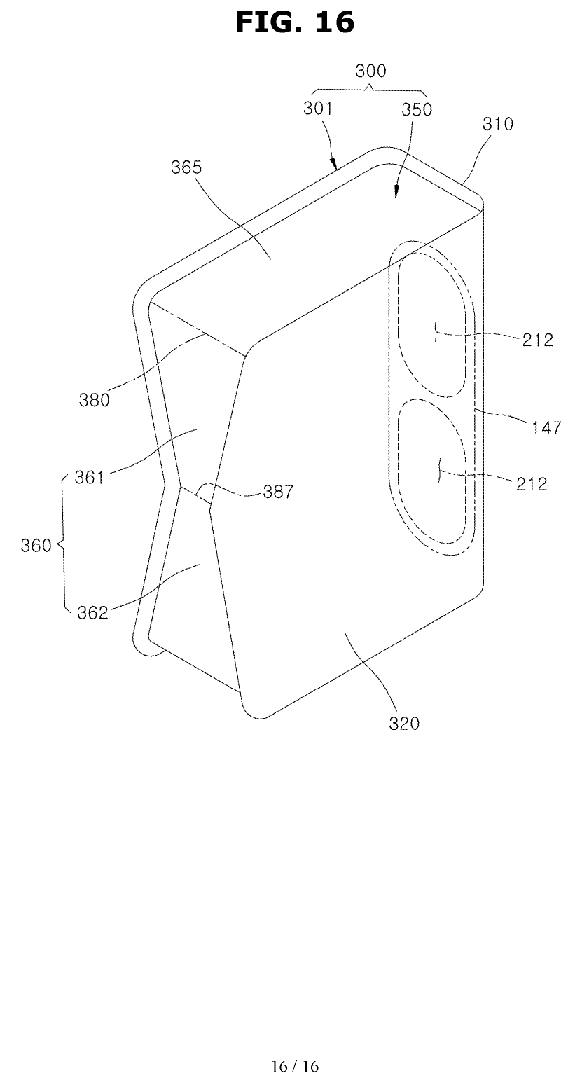

FIG. 15 is a developed view illustrating an example of a base panel and a cover panel included in a front chamber of an airbag apparatus according to a third embodiment of the present disclosure. FIG. 16 is a perspective view illustrating a state in which the front chamber, formed by coupling the base panel and the cover panel of FIG. 15, is inflated and deployed.

Referring to FIGS. 8, 15, and 16, an airbag apparatus according to the third embodiment of the present disclosure may include a side chamber 110, a front chamber 300, an upper panel 170, a lower panel 180, and an inflator 101, as in the airbag apparatus 100 according to the first embodiment of the present disclosure.

Because the side chamber 110, the upper panel 170, the lower panel 180, and the inflator 101 are identical to components having the same names included in the airbag apparatus 100 according to the first embodiment of the present disclosure, only the front chamber 300 will be described below.

The front chamber 300 may include a base panel 301 coupled to the side chamber 110, and a cover panel 350 coupled to an outer peripheral portion of the base panel 301.

The base panel 301 may include a first base portion 310, a second base portion 320, and a third base portion 330. The first base portion 310 may be positioned to face the inner panel 120 of the side chamber 110.

The first base portion 310 may be disposed to overlap an outer surface of the front end 122 of the inner panel 120. The second base portion 320 may be positioned to face the seated occupant. The second base portion 320 may be bent along a first base bending line 340 from a first side of the first base portion 310 with respect to a width direction of the first base portion 310.

The third base portion 330 may be positioned to face away from the seated occupant 1 with the second base portion 320 interposed therebetween. The third base portion 330 may be bent along a second base bending line 342 from a second side of the first base portion 310 with respect to the width direction of the first base portion 310. The first base portion 310 may be interposed between the second base portion 320 and the third base portion 330.

The cover panel 350 may include a first cover portion 360, a second cover portion 365, and a third cover portion 370. The first cover portion 360 may be spaced apart from the first base portion 310, and may be positioned to face the first base portion 310.

The second cover portion 365 may be bent along a first cover bending line 380 from a first side of the first cover portion 360 with respect to a longitudinal direction of the first cover portion 360. The second cover portion 365 may be positioned above the first cover portion 360.

The third cover portion 370 may be bent along a second cover bending line 382 from a second side of the first cover portion 360 with respect to the longitudinal direction of the first cover portion 360. The third cover portion 370 may be positioned below the first cover portion 360. The first cover portion 360 may be interposed between the second cover portion 365 and the third cover portion 370. The front chamber 300 may be formed by sewing an outer peripheral portion of the base panel 301 and an outer peripheral portion of the cover panel 350 along an outer sewing line 385.

The first cover portion 360 may include a first tapered portion 361 and a second tapered portion 362. The first tapered portion 361 may have a width increasing from an intermediate point between an upper end and a lower end of the first cover portion 360 toward the upper end of the first cover portion 360. A planar shape of the first tapered portion 361 may be a trapezoidal shape.

The second tapered portion 362 may have a width increasing from the intermediate point between the upper end and the lower end of the first cover portion 360 toward the lower end of the first cover portion 360. A planar shape of the second tapered portion 362 may be a trapezoidal shape. The shapes of the first tapered portion 361 and the second tapered portion 362 may be symmetrical with respect to the intermediate point.

Based on an inflated and deployed state of the front chamber 300, a height of the upper end of the first cover portion 360 may be the same as a height of the first cover bending line 380, and a height of the lower end of the first cover portion 360 may be the same as a height of the second cover bending line 382.

A height of the intermediate point between the upper end and the lower end of the first cover portion 360 may be the same as a height of a boundary line 387 between the first tapered portion 361 and the second tapered portion 362. The boundary line 387 may be an imaginary line extending in parallel with the width direction of the first cover portion 360 at a center point with respect to the longitudinal direction of the first cover portion 360.

A width of the second cover portion 365 may be the same as a width of the first tapered portion 361 at a boundary point between the first cover portion 360 and the second cover portion 365, that is, at the first cover bending line 380. The second cover portion 365 may extend with a constant width along a longitudinal direction of the cover panel 350.

A width of the third cover portion 370 may be the same as the width of the second tapered portion 362. The third cover portion 370 may extend with a constant width along the longitudinal direction of the cover panel 350.

The first tapered portion 361 may include a pair of first inclined cover edges 364 that are inclined at opposite widthwise ends of the cover panel 350. The second tapered portion 362 may include a pair of second inclined cover edges 366 that are inclined at opposite widthwise ends of the cover panel 350.

The second base portion 320 and the third base portion 330 may respectively include a pair of first inclined base edges 323 and 333 corresponding to the pair of first inclined cover edges 364, and may respectively include a pair of second inclined base edges 324 and 334 corresponding to the pair of second inclined cover edges 366.

The pair of first inclined base edges 323 and 333 and the pair of second inclined base edges 324 and 334 may be provided at opposite longitudinal ends of the base panel 301 that is in an unfolded state.

The width direction of the first base portion 310 may be a direction perpendicular to the vertical direction and also perpendicular to the thickness direction of the base panel 301. The width direction of the first cover portion 360 may be a direction perpendicular to the vertical direction and also perpendicular to the thickness direction of the cover panel 350.

The longitudinal direction of the first base portion 310 may be perpendicular to a longitudinal direction of the base panel 301 that is in an unfolded state. The width direction of the first base portion 310 may be the same as the longitudinal direction of the base panel 301 that is in an unfolded state. The longitudinal direction of the first cover portion 360 may be the same as a longitudinal direction of the cover panel 350 that is in an unfolded state.

In a state where the base panel 301 and the cover panel 350 are coupled, outer peripheral portions of the second cover portion 365 and the third cover portion 370 may be coupled to opposite widthwise ends of the base panel 301 by sewing.

The pair of first inclined cover edges 364 and the pair of second inclined cover edges 366 of the first cover portion 360 may be coupled by sewing to the pair of first inclined base edges 323 and 333 and the pair of second inclined base edges 324 and 334 provided at opposite longitudinal ends of the base panel 301.

With the aforementioned configuration, a thickness of the upper portion of the front chamber 300 may be greater than that of an intermediate portion between the upper and lower portions of the front chamber 300. The thickness of the upper portion of the front chamber 300 may be the same as that of the lower portion of the front chamber 300. A thickness of the front chamber 300 may be defined as a distance between the second base portion 320 and the third base portion 330 in a front-rear direction of the seated occupant 1 when the front chamber 300 is inflated.

The front chamber 300 may include at least one front chamber internal tether 345 to limit the thickness of the front chamber 300. One end of the front chamber internal tether 345 may be coupled to the second base portion 320 by sewing along a sewing line 346, and a remaining end of the front chamber internal tether 345 may be coupled to the third base portion 330 by sewing along a sewing line 347.

Unlike illustration in the drawings, a front chamber according to another embodiment of the present disclosure may include an upper front chamber internal tether, a lower front chamber internal tether, and an intermediate front chamber internal tether.

The upper front chamber internal tether may limit a thickness between an upper portion of the second base portion and an upper portion of the third base portion at a height corresponding to a height of the first tapered portion. The lower front chamber internal tether may limit a thickness between a lower portion of the second base portion and a lower portion of the third base portion at a height corresponding to a height of the second tapered portion. The intermediate front chamber internal tether may limit a thickness between an intermediate portion of the second base portion and an intermediate portion of the third base portion at a height of the boundary point between the first tapered portion and the second tapered portion.

To allow gas supplied from the inflator 101 to flow between the side chamber 110 and the front chamber 300, the inner panel 120 (see FIG. 10) of the side chamber 110 and the base panel 301 of the front chamber 300 may respectively include through-holes 126 and 312 that are aligned with each other. For example, a front chamber connection through-hole 126 may be formed in a front end 122 of the inner panel 120, and a side chamber connection through-hole 312 may be formed in a first base portion 310 of the base panel 301.

To prevent gas from leaking between the inner panel 120 and the base panel 201, a hole-defining portion of the inner panel 120 surrounding the through-hole 126 and a hole-defining portion of the base panel 301 surrounding the through-hole 312 may be sewn together. For example, the first base portion 310 may be coupled to the front end 122 of the inner panel 120 by sewing, along the sewing line 147, the hole-defining portion provided around the front chamber connection through-hole 126 in the inner panel 120 and the hole-defining portion provided around the side chamber connection through-hole 312 in the first base portion 310.

Although embodiments of the present disclosure have been described with reference to the accompanying drawings, these embodiments are provided for the illustrative purpose, and it will be apparent to those skilled in the art that various modifications and equivalent embodiments can be made from the embodiments disclosed herein. Therefore, the true technical scope of the disclosure should be defined by the following claims.

What is claimed is:

1. An airbag apparatus comprising:
a side chamber disposed at a seatback of a seat of a vehicle and configured to be deployed to protrude from a lateral side of the seatback and face a lateral side of an occupant seated in the seat; and
a front chamber connected to the side chamber to allow gas to flow between the front chamber and the side chamber and configured to be deployed to protrude in a direction bent from the side chamber and face a front surface of the seated occupant, the front chamber including a base panel coupled to the side chamber and a cover panel coupled to an outer peripheral portion of the base panel.

2. The airbag apparatus of claim 1, wherein the base panel comprises:
a first base portion facing the side chamber;
a second base portion bent from a first side of the first base portion with respect to a width direction of the first base portion, the second base portion facing the seated occupant; and
a third base portion bent from a second side of the first base portion with respect to the width direction of the first base portion, the third base portion facing away from the seated occupant with the second base portion interposed between the third base portion and the seated occupant.

3. The airbag apparatus of claim 2, wherein the side chamber comprises:
an inner panel facing the seated occupant, wherein the first base portion is attached to the inner panel; and
an outer panel facing away from the seated occupant with the inner panel interposed between the outer panel and the seated occupant,
wherein the inner panel and the base panel respectively include a plurality of through-holes aligned with each other to allow gas to flow between the side chamber and the front chamber.

4. The airbag apparatus of claim 3, wherein a first hole-defining portion of the inner panel surrounding a corresponding through-hole and a second hole-defining portion of the base panel surrounding a corresponding through-hole are sewn to each other so that gas is prevented from leaking between the inner panel and the base panel.

5. The airbag apparatus of claim 2, wherein the cover panel comprises:
a first cover portion spaced apart from the first base portion, and facing the first base portion;
a second cover portion bent from a first side of the first cover portion with respect to a longitudinal direction of the first cover portion, the second cover portion being positioned above the first cover portion; and
a third cover portion bent from a second side of the first cover portion with respect to the longitudinal direction of the first cover portion, the third cover portion being positioned below the first cover portion.

6. The airbag apparatus of claim 5, wherein:
the first base portion and the first cover portion extend in a vertical direction, and
a width of the first base portion is identical to that of the first cover portion.

7. The airbag apparatus of claim 6, wherein:
the width of the first base portion is constant along a longitudinal direction of the first base portion, and
the width of the first cover portion is constant along the longitudinal direction of the first cover portion.

8. The airbag apparatus of claim 1, further comprising an upper tether connecting an upper portion of the seatback and the side chamber.

9. The airbag apparatus of claim 1, further comprising a lower tether connecting a side portion of the seatback and the side chamber.

10. The airbag apparatus of claim 1, further comprising an inflator disposed at the side chamber and supported by the seatback, the inflator being configured to provide gas that deploys the side chamber and the front chamber.

11. An airbag apparatus, comprising:
a side chamber disposed at a seatback of a seat of a vehicle, and configured to be deployed to protrude from a lateral side of the seatback and face a lateral side of a seated occupant in the seat; and
a front chamber connected to the side chamber to allow gas to flow between the front chamber and the side chamber, and configured to be deployed to protrude in a direction bent from the side chamber and face a front surface of the seated occupant, the front chamber including a base panel coupled to the side chamber, and a cover panel coupled to an outer peripheral portion of the base panel,
wherein a thickness of an upper portion of the front chamber is greater than that of an intermediate portion between the upper portion and a lower portion of the front chamber.

12. The airbag apparatus of claim 11, wherein the base panel comprises:
a first base portion facing the side chamber;
a second base portion bent from a first side of the first base portion with respect to a width direction of the first base portion, the second base portion facing the seated occupant; and
a third base portion bent from a second side of the first base portion with respect to the width direction of the first base portion, the third base portion facing away from the seated occupant with the second base portion interposed between the third base portion and the seated occupant.

13. The airbag apparatus of claim 12, wherein the cover panel comprises:
a first cover portion spaced apart from the first base portion, and facing the first base portion;
a second cover portion bent from a first side of the first cover portion with respect to a longitudinal direction of the first cover portion, the second cover portion being positioned above the first cover portion; and
a third cover portion bent from a second side of the first cover portion with respect to the longitudinal direction of the first cover portion, the third cover portion being positioned below the first cover portion.

14. The airbag apparatus of claim 13, wherein the first cover portion comprises:
a tapered portion having a width increasing from an intermediate point between an upper end and a lower end of the first cover portion toward the upper end of the first cover portion; and
a narrow-width portion extending from the intermediate point of the first cover portion to the lower end of the first cover portion, with a width identical to that of the tapered portion at the intermediate point of the first cover portion.

15. The airbag apparatus of claim 14, wherein each of the second base portion and the third base portion comprises:
an inclined base edge corresponding to one of a plurality of inclined cover edges of the tapered portion; and
a parallel base edge corresponding to one of a plurality of parallel cover edges of the narrow-width portion that are parallel to a longitudinal direction of the cover panel.

16. The airbag apparatus of claim 13, wherein the first cover portion comprises:
a first tapered portion having a width increasing from an intermediate point between an upper end and a lower end of the first cover portion toward the upper end of the first cover portion; and
a second tapered portion having a width increasing from the intermediate point of the first cover portion toward the lower end of the first cover portion.

17. The airbag apparatus of claim 16, wherein each of the second base portion and the third base portion comprises:
a first inclined base edge corresponding to one of a plurality of first inclined cover edges of the first tapered portion; and
a second inclined base edge corresponding to one of a plurality of second inclined cover edges of the second tapered portion.

18. The airbag apparatus of claim 12, wherein the front chamber includes at least one front chamber internal tether configured to limit a thickness of the front chamber.

19. The airbag apparatus of claim 12, wherein the side chamber comprises:
an inner panel facing the seated occupant, wherein the first base portion is attached to the inner panel; and
an outer panel facing away from the seated occupant with the inner panel interposed between the outer panel and the seated occupant,
wherein the inner panel and the base panel respectively include a plurality of through-holes aligned with each other to allow gas to flow between the side chamber and the front chamber.

20. The airbag apparatus of claim 19, wherein a first hole-defining portion of the inner panel surrounding a corresponding through-hole and a second hole-defining portion of the base panel surrounding a corresponding through-hole are sewn to each other so that gas is prevented from leaking between the inner panel and the base panel.
